(19) United States
(12) Patent Application Publication
(10) Pub. No.: US 2015/0233565 A1
(43) Pub. Date: Aug. 20, 2015

(54) LIGHT-EMITTING DIODE LIGHTING DEVICE WITH RADIATION, WATERPROOF, AND DAMPPROOF STRUCTURE USING FLUID

(71) Applicants: Jong Seok LEE, Seoul (KR); Myung Hee KIM, (US); VIB. CO., LTD, Seoul (KR)

(72) Inventor: Jong Seok Lee, Seoul (KR)

(21) Appl. No.: 14/402,315

(22) PCT Filed: Nov. 1, 2013
(86) PCT No.: PCT/KR2013/009842

§ 371 Date: Nov. 20, 2014

(30) Foreign Application Priority Data
Nov. 5, 2012 (KR) 10-2012-0123900
Dec. 28, 2012 (KR) 10-2012-0156448

(51) Int. Cl. F21V 29/56; F21V 8/00; F21V 31/04; F21K 99/00

(52) U.S. Cl. CPC F21V 29/56; F21K 9/50; G02B 6/0096; F21V 31/04; F21Y 2101/02

(57) ABSTRACT

The present invention relates to an LED lighting device in a heat radiating, waterproof and moisture-proof structure using a fluid, wherein light from an LED element is concentrated to a lens such that the light with high intensity of illumination reaches a long distance and a frame is filled with a fluid such that heat radiation is expedited and water and moisture penetration phenomenon is prevented, thereby being used both under water and on the ground.

The LED lighting device according to the present invention comprises: a front frame in which a fluid space is formed at its back side, through-holes are formed, at regular intervals, at its front side and a fluid inlet is formed; a back frame in a flat shape to be connected to the back side of the front frame to complete a frame and to close the fluid space; a PCB with LEDs installed at regular intervals, at its front side, to emit light through the through-holes of the front frame; and a fluid which is a high molecular compound extracted from mineral oil, to fill the fluid space of the front frame.

### TECHNICAL FIELD

The present invention relates to a light-emitting diode (LED) lighting device, and more particularly, to an LED lighting device in a heat radiating, waterproof and moisture-proof structure using a fluid, wherein light from an LED element is concentrated to a lens such that the light with high intensity of illumination reaches a long distance and a frame is filled with a fluid such that heat radiation is expedited and water and moisture penetration phenomenon is prevented, thereby being used both under water and on the ground.

### BACKGROUND ART

A light-emitting diode (LED) has the advantages in that power consumption is low, the lifespan is semi-permanent, the time required for lighting is shorter and natural light is produced. Due to these advantages, the LED light has been well used as a light source in a street lamp, a security lamp, a tunnel lamp, a fish attraction lamp, a lamp for a playground, etc. The demand for the LED light has geometrically increased to replace many existing light sources, based on the point that the LED light can influence animals and plants and a human body by using a particular single wavelength which could not be realized in the existing light sources.

Let's take the example of a fish attracting lamp. Fish may be divided into phototactic fish species moving towards stimulus of light and non-phototactic fish species moving away from it, based on the reaction to light. In general, a fish attraction lamp is used to catch the phototactic fish, such as squid, anchovy, mackerel, horse mackerel, mackerel pike, hairtail, eel, sardine, etc. Previously, a metal halide lamp was mostly used as a fish attracting lamp. However, in the case of a metal halide lamp, since luminance efficiency is low, power consumption is high and the lamp needs to be periodically replaced, it is costly. Accordingly, fish attraction lamps using LEDs have been widely used.

Korean Patent Laid-open Publication No. 2010-129800 relates to an “LED underwater lamp and fish attraction lamp actively maneuvering to a water pressure change”. The fish attraction lamp according to the conventional art has a flexible enclosure which is formed in an envelop-shaped structure by joining and sealing two sheets of transparent thin films by using joint means. A printed circuit board (PCB) having an LED is installed inside the enclosure. The inside of the enclosure is filled with an insulated liquid light transmitting material, providing the fish attraction lamp having a liquid heat radiation effect and a waterproof effect under different pressure conditions.

However, since the structure of the aforementioned fish attraction lamp is in the envelope-shaped enclosure, its surface area is large. Due to the large surface area, the fish attraction lamp under water is pushed by an ocean current and the enclosure itself continuously shakes. Then, since the direction of illumination is not fixed, the efficiency of fish attraction as the fish attraction lamp is reduced and it cannot be used for any other purpose than the fish attraction lamp under water.

### DISCLOSURE

### Technical Problem

Therefore, it is an object of the present invention to solve the above problems and to provide an LED lighting device in a heat radiating, waterproof and moisture-proof structure using a fluid, wherein an inside of a frame is filled with the fluid so that the cooling effect is excellent, water and moisture penetration phenomenon is prevented under water, the shape of the frame is not changed even by high water pressure and therefore it is possible to be used both under water and on the ground.

It is another object of the present invention to provide an LED lighting device in a heat radiating, waterproof and moisture-proof structure using a fluid, wherein light from an LED element is concentrated to a lens such that the light with high intensity of illumination reaches a long distance, open spaces are positioned among the frames, to prevent the frames from being shaken by the ocean current while the lighting device is under water such that light is directed in a fixed direction and to prevent the lighting device from falling down or being broken by wind pressure even if a strong wind blows on the ground.

### Technical Solution

In accordance with an embodiment of the present invention, there is provided an LED lighting device in a heat radiating, waterproof and moisture-proof structure using a fluid, comprising: a front frame in which a fluid space is formed at its back side, through-holes are formed, at regular intervals, at its front side and a fluid inlet is formed; a back frame in a flat shape to be connected to the back side of the front frame to complete a frame and to close the fluid space; a PCB with LEDs installed at regular intervals, at its front side, to emit light through the through-holes of the front frame; and a fluid which is a high molecular compound extracted from mineral oil, to fill the fluid space of the front frame.

In accordance with another embodiment of the present invention, there is provided an LED lighting device in a heat radiating, waterproof and moisture-proof structure using a fluid, comprising: a lighting pipe in a cylindrical shape made of a transparent material; a PCB positioned inside the lighting pipe, on which LED elements are installed at equal intervals and lengthwise; a fluid to fill the inside of the lighting pipe, the fluid being a high molecular compound extracted from mineral oil; and a lower frame and an upper frame each having a cylindrical shape, to be respectively connected to a lower end and an upper end of the lighting pipe.

Preferably, the lighting pipe includes an inner frame in a flat shape or a shape in which a plane is polygonal and the PCB is attachably connected to the inner frame and it is further provided with at least one of a camera, a water level sensor, a proximity sensor for fish attraction and a current leak sensor.

Preferably, among the LED colors, the wavelength of a blue color is 400˜500 nm, the wavelength of a green color is 500˜570 nm and the wavelength of a red color is 600˜800 nm and the LED lighting device further comprises a remote controller to change or flicker the colors of the LED elements.

In accordance with another embodiment of the present invention, there is provided an LED lighting device in a heat radiating, waterproof and moisture-proof structure using a fluid, comprising: a lighting pipe in a cylindrical shape made of a transparent material; an inner frame positioned inside the lighting pipe and having a shape in which a plane is circle or polygonal; a stripe/rope-shaped LED attached to an outer circumferential surface of the inner frame; a fluid to fill the inside of the lighting pipe, the fluid being a high molecular compound extracted from mineral oil; and a lower frame and an upper frame each having a cylindrical shape, to be respectively connected to a lower end and an upper end of the lighting pipe.

### Advantageous Effects

In the present invention, the LED lighting device in a heat radiating, waterproof and moisture-proof structure using a fluid is available both under water and on the ground. Since the inside of a frame of the LED lighting device is filled with the fluid, not only the cooling effect is excellent but also the water and moisture penetration phenomenon is prevented under water and on the ground. Further, even if the high water pressure is applied to the frame of the LED lighting device in the deep sea, the shape of the frame is not deformed due to the incompressibility of the fluid filled inside the frame. In addition, even though the light lamps which are used in a humid place on the ground, such as a tree lamp, a fountain lamp, a landscape lamp, a sidewalk block lamp, etc., are very well waterproof-manufactured, the moisture penetration phenomenon occurs because of a temperature difference between the inside and outside of the lamp, generating water condensation inside the lamp and therefore weakening the intensity of illumination or making it impossible to be used due to a circuit damage. However, the LED lighting device according to the present invention does not generate the moisture penetration phenomenon because the inside of the frame is filled with the fluid.

Furthermore, in the LED lighting device according to the present invention, since the light emitted from the LED elements is concentrated and directed by lenses, the light having the high intensity of illumination is able to reach a long distance. In addition, since the open spaces are positioned among the frames, even if the LED lighting device is placed under water, the ocean current passes through the open spaces and therefore, the frames do not shake due to the flow of the ocean current and it is able to direct light in a desired direction. Thus, when the LED lighting device is used as a fish attraction lamp, the fish attracting effect is high and when it is installed on the ground, it does not fall down or break by the wind pressure even if a strong wind blows.

### DESCRIPTION OF DRAWINGS

These and other aspects and advantages of the present invention will become apparent and more readily appreciated from the following description of the embodiment(s), taken in conjunction with the accompanying drawings, in which:

FIG. 1 is a front view and a side view of an LED lighting device according to a first embodiment of the present invention;

FIG. 2 is a sectional view taken along a Line A-A shown in FIG. 1;

FIG. 3 illustrates heat radiation fins shown in FIG. 2;

FIG. 4 is a front view and a side view of an LED lighting device according to a second embodiment of the present invention;

FIG. 5 is a front view of an LED lighting device according to a third embodiment of the present invention;

FIG. 6 is an assembly view of an LED lighting device according to a fourth embodiment of the present invention;

FIG. 7 is an exploded view of the lighting device shown in FIG. 6;

FIG. 8 illustrates a lighting pipe and a lighting unit of the lighting device according to the fourth embodiment of the present invention;

FIG. 9 illustrates a partial exploded view of the lighting unit shown in FIG. 8;

FIG. 10 illustrates a lighting pipe and a lighting unit of an LED lighting device according to a fifth embodiment of the present invention; and

FIG. 11 is an assembly view of an LED lighting device using a strip/rope-typed LED according to a sixth embodiment of the present invention.

### BEST MODE

The technical characteristics of an LED lighting device according to the present invention are that:

the inside of a frame of the lighting device is filled with a fluid such that the cooling effect is excellent, the water and moisture penetration phenomenon is prevented under water, and the shape of the frame is not changed due to the incompressibility of the fluid filling the inside of the frame even under high water pressure; and

open spaces are positioned among the frames, to prevent the lighting device from being shaken by the ocean current such that light is directed in a fixed direction and to prevent the lighting device from falling down or breaking by the wind pressure even if a strong wind blows on the ground.

An LED lighting device 10, 20 according to the first, second embodiments of the present invention is available for not only a lamp used on the ground but also a fish attraction lamp used under water. The LED lighting device 10, 20 comprises: a front frame 11, 21 and a back frame 12, 22 connected to a back side of the front frame 11, 21, thereby completing a frame, a printed circuit board (PCB) 13 with LEDs emitting light for illumination, and a fluid 18 filling a fluid space in the frame. The frame is manufactured by using metal, glass or plastic.

The fluid space is formed in the back side of the front frame 11, 21 and through-holes are formed, at regular intervals, in the front side of the front frame 11, 21. A fluid inlet 11a, 21a is formed at an upper, lower or side position of the front frame 11, 21, to be used when the fluid space is filled with the fluid 18.

The back frame 12, 22 is a flat-shaped member and is joined to the back side of the front frame 11, 21 by inserting a gasket, etc. and joining together by using a joint means such as a bolt, to close the fluid space. An adhesive may be used to close the frame.

The LED 14 is mounted, at regular intervals, at the front side of the PCB 13, to emit light for illumination. The LED 14 is positioned to emit light through the through-hole formed in the front side of the front frame 11, 21. If necessary, an infrared chip may be mounted instead of the LED 14. Further, a camera may be mounted instead of the LED 14, to be used to watch ground and underwater conditions. The PCB 13 is fixed to the front frame 11, 21 positioned in front of the LED 14 by using PCB fixing bolts 13a. Moreover, when there is no back heat radiation panel, a circuit unit 13b is provided with a bimetal 13c. In this case, when heat emitted from the LED 14 rises beyond a certain temperature, it is desirable to protect a circuit by turning off the circuit.

The fluid space of the front frame 11, 21 (indicating the fluid space between the PCB 13 and the back frame 12, 22) is filled with the fluid 18. The reasons for filling the fluid space with the fluid 18 are: first, to absorb heat generated from the LED 14 and to release it; second, using the peculiar incompressibility of the fluid 18, to prevent the lighting device from being deformed and damaged by changes in atmospheric pressure, water pressure and temperature applied to the lighting device when it is used under water and on the ground, and third, as a buffering agent, to protect the lighting device from an outside impact.

Preferably, the fluid 18 uses a high molecular compound extracted from mineral oil. The fluid 18 having a transparent color (clear) is to have a fluidity range of −50˜200° C. and it should not be discolored by light and heat with high water separation. Since the fluid 18 fills the fluid space between the PCB 13 and the back frame 12, 22 the filling fluid 18 absorbs the heat generated from the LED 14 and releases it and further prevents the occurrence of the water and moisture penetration phenomenon.

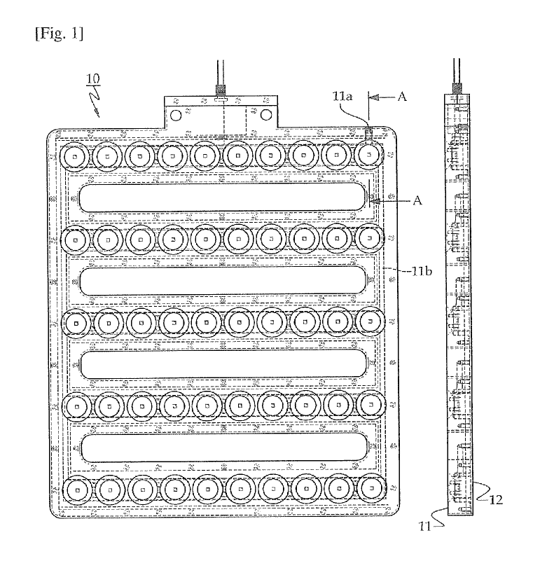

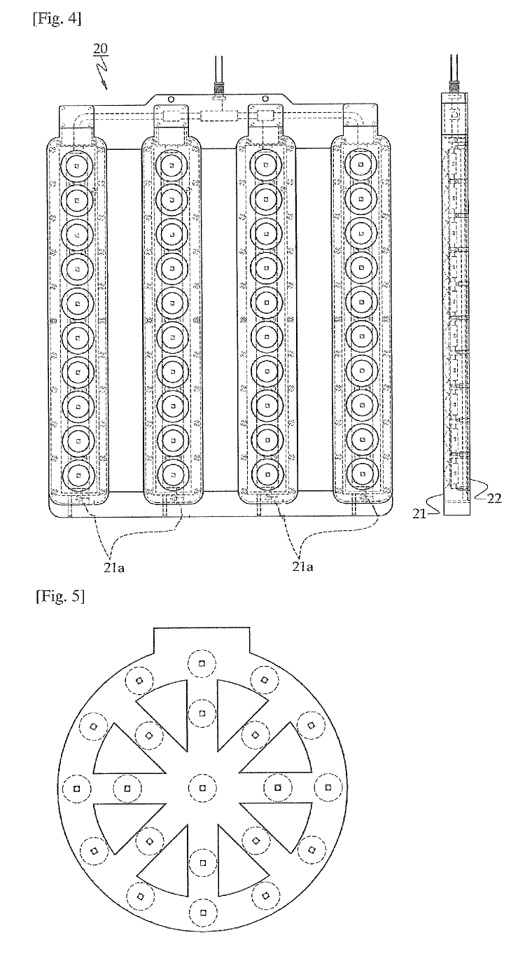

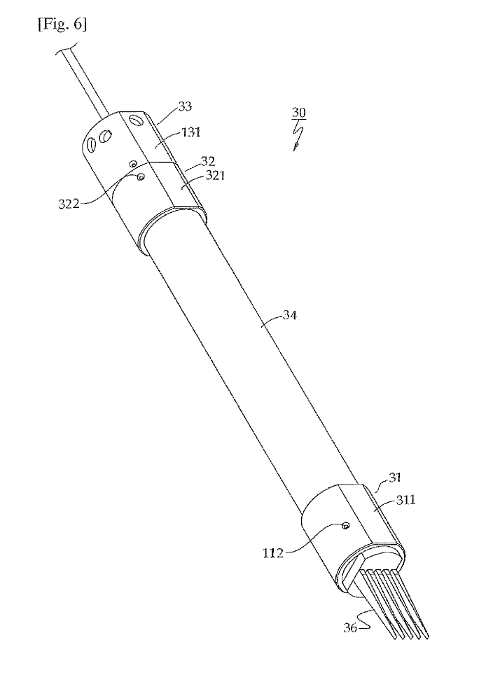

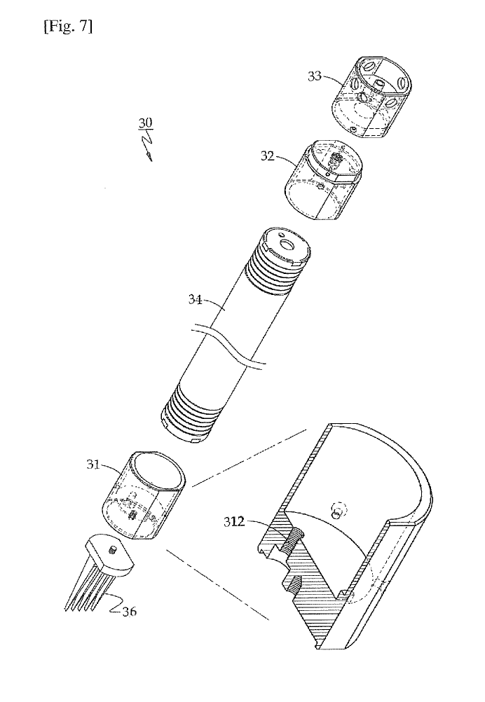

A frame case may be formed of one frame in a single line where the front frame 11, 12 is joined to the back frame 21, 22. However, it is preferable to use the frame case formed of a plurality of the frames in the structure in which the front frame 11, 12 and the back frame 21, 22 are joined together in 2˜6 lines, at equal intervals, crosswise or lengthwise, and the ends of the frames are connected together to be in a single body. When the frame case is formed of a plurality of the frames, each frame may be filled with the fluid 18 (see FIG. 4) but a fluid channel 11b may be formed such that the fluid 18 filled in each of the frames can communicate together (see FIGS. 1 and 5). A wire to supply power is inserted through the fluid channel 11b.

As shown in FIGS. 1, 4 and 5, the frame case includes open spaces among the frames arranged in a plurality of lines (i.e., the number of the frames). Therefore, when the LED lighting device 10, 20 is used under water, since the ocean current passes through the open spaces positioned among the frames, the LED lighting device 10, 20 does not shake even though the ocean current flows through. Further, when the LED lighting device 10, 20 is used on the ground, even though a strong wind blows, since the strong wind passes through the open spaces positioned among the frames, the LED lighting device 10, 20 is prevented from falling down or being damaged. The arrangement of the frames may be changed in any shapes other than that shown in the attached drawings.

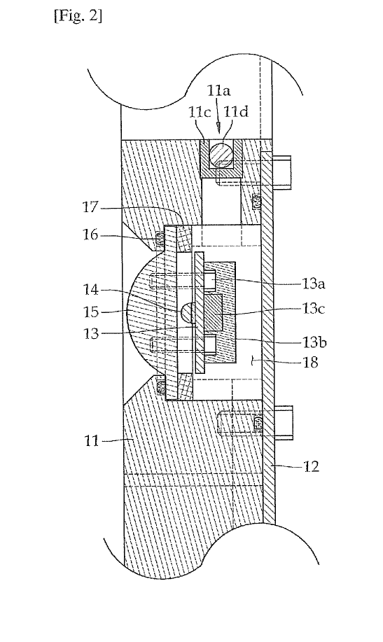

As shown in FIG. 2, after supplying the fluid 18 through the fluid inlet 11a of the front frame 11, the fluid inlet 11a needs to be closed. To this end, a sealing ball frame 11c is inserted and a sealing ball 11d is inserted into the fluid inlet 11a formed in the front frame 11. Then, the sealing ball frame 11c is pressed against the front frame 11 by the sealing ball 11d so that the fluid inlet 11a is closed.

An O-ring 16 is inserted between the through-hole formed in the front frame 11 and a lens 15, nuts (female screws) are placed around a position where the lens 15 of the front frame 11 is inserted, and lens clamping bolts 17 are placed behind the lens 15 and are fastened with the nut, to fix the lens 15. The PCB 13 is positioned behind the lens clamping bolts 17 and it is fixedly connected to the front frame 11 by the PCB fixing bolts 13a. An adhesive may be used instead of the O-ring 16.

A transparent resin plate or glass plate may be installed in the front of each LED 14. However, it is preferable to install the lens 15 in the front of each LED 14. The color of the lens 15 may be various. The shape of the lens 15 may be differently formed, based on the shape of the through-hole formed in the front frame 11. In the present invention, since the lens 15 is installed to concentrate light and direct the light, the light with high intensity of illumination is able to reach a long distance.

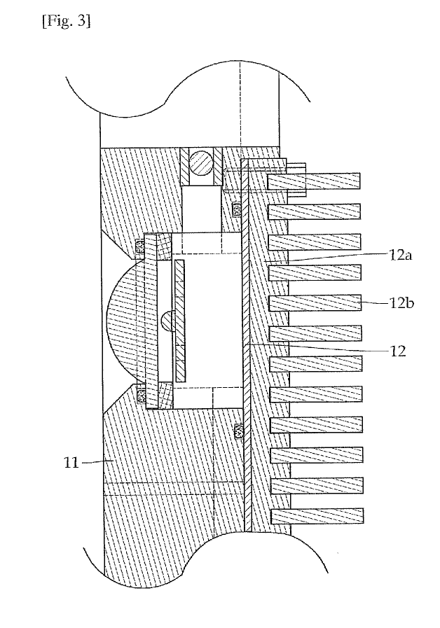

When the LED lighting device 10, 20 is used under water, since it is naturally cooled by water, the heat radiation does not matter. However, when the LED lighting device 10, 20 is used on the ground, it needs to release the heat generated during the LED 14 emits light. To this end, it is preferable to apply foaming epoxy resin 12a, at a certain thickness, to an outer surface of the back frame 12 and to install a back heat radiation panel where heat radiation fins 12b are installed at equal intervals (see FIG. 3). For the back heat radiation panel, an aluminum heat radiation panel may be used without using the foaming epoxy resin.

An LED lighting device 30 according to the fourth embodiment of the present invention comprises the following basic components: a lighting pipe 34 made of a high transparent material; a lower frame 31 and an upper frame 32 respectively connected to a lower end and an upper end of the lighting pipe 34; a fluid filling an inside of the lighting pipe 34; and a PCB 41 with an LED element 42 to be positioned in the lighting pipe 34. The inside of the lighting pipe 34 may be filled with epoxy resin instead of the fluid.

The lighting pipe 34 has a cylindrical shape. The lighting pipe 34 is made of a material having high transparency, such as plastic series or glass, so that the light emitted from a lighting unit 40 positioned inside the lighting pipe 34 is transmitted. Stoppers 341, 342 are respectively connected to a top and a bottom of the lighting pipe 34 such that an inner frame 35 is secured in the center of the lighting pipe 34. The lighting pipe 34 may be a polygonal column in shape, instead of the cylindrical shape. Further, the lighting pipe 34 may be manufactured in a double tube shape in consideration of the cooling effect even though it is not shown in the attached drawings. In this case, a hollow may be formed along the center of the lighting pipe 34, lengthwise.

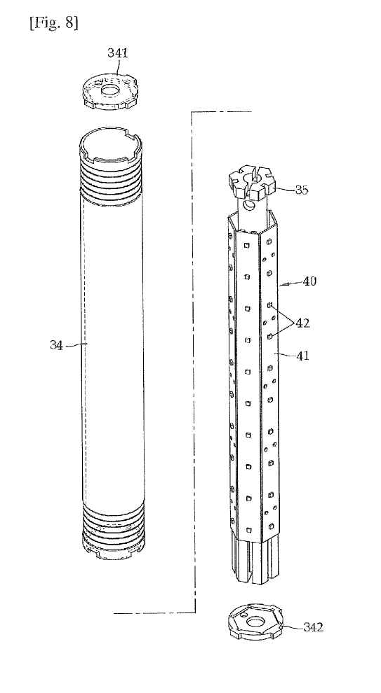

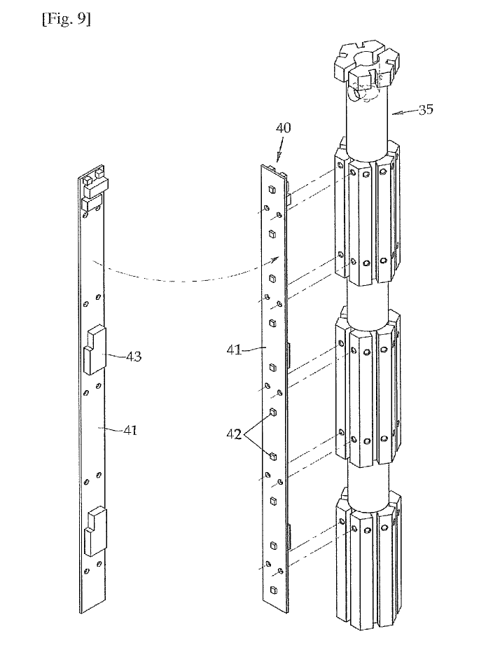

Preferably, the stoppers 341, 342 to be respectively connected to the top and bottom of the lighting pipe 34 include grooves which are shaped to receive the PCB 41 or upper end and lower ends of the inner frame 35 (see FIG. 8). Further, if the grooves shaped to receive the PCB 41 or the upper and lower ends of the inner frame 35 are formed in the inner surfaces of the lower frame 31 and the upper frame 32 although not shown in the attached drawings, the stoppers 341, 342 may not be used to be connected to the top and bottom of the lighting pipe 34.

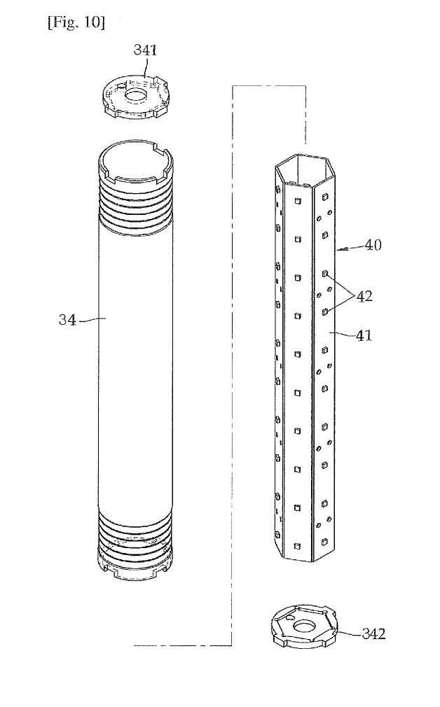

The inner frame 35 is inserted through the total inside length of the lighting pipe 34. The inner frame 35 may be made of a flat-shaped member. However, it is preferable to make the flat shape to a polygonal shape for the illumination in all directions. The PCB 41 is attached to the outer surface of the polygonal shape of the inner frame 35 (see FIGS. 8 and 9). If the length of the LED lighting device 30 is not long, the PCB 41 is directly insertedly fixed to the stoppers 341, 342 (see FIG. 10), without inserting the inner frame 35. If the length of the LED lighting device 30 is not long and the stoppers 341, 342 are not connected, the PCB 41 may be directly fixedly installed to the lower frame 31 and the upper frame 32.

The PCB 41 is attached and connected to the outer surface of the inner frame 35. The LED elements 42 are mounted, at equal intervals, at the front side of the PCB 41, lengthwise. A lens (not shown) may be installed at the front of each of the LED elements 42 to direct light to a long distance. Further, if needed, an infrared chip or a camera may be installed instead of the LED elements 42, to be used to watch the ground and underwater conditions.

At least one of a water level sensor, a proximity sensor for fish attraction and a current leak sensor is provided in a control circuit and sensor unit 43 at the back panel of the PCB 41. The water level sensor is to measure a water level by measuring water pressure. The proximity sensor for fish attraction is to know the extent of attracting a target fish species when the LED lighting device 30 is used as a fish attraction lamp. The current leak sensor is to sense an abnormal operation by a short circuit. Further, it is preferable to include bimetal in the control circuit unit, to block or turn off the circuit and to protect it if the heat emitted from the LED elements 42 rises above a certain temperature.

The inside of the lighting pipe 34 is filled with the fluid, to release the heat generated from the LED elements 42. The fluid absorbs the heat generated from the LED elements 42, so as to be released. Using the peculiar incompressibility of the fluid, the fluid also prevents the LED lighting device from being deformed and damaged by changes in pressure or temperature applied to the LED lighting device when the LEO lighting device is used under water or on the ground. The fluid functions as a buffering agent to protect the LED lighting device from an external impact.

Preferably, the fluid is a high molecular compound extracted from mineral oil. The fluid having a transparent color (clear) is to have a fluidity range of −50˜200° C. and it should not be discolored by light and heat with high water separation. This kind of fluid is supplied into the inside of the lighting pipe 34 through a fluid inlet 313 formed at the lower frame 31 and then the fluid inlet 313 is closed. The fluid filling the inside of the lighting pipe 34 absorbs the heat generated from the LED elements 42 and release the heat. Further, the fluid prevents the water and moisture penetration phenomenon in the lighting pipe 34 and it functions as the buffering agent to protect the LED lighting device 30.

The lower frame 31 and the upper frame 32 in the cylindrical shape (the same shape as the lighting pipe 34) are respectively bonded to be connected to the lower end and the upper end of the lighting pipe 34. After that, to support the connection, bolts may be fastened through bolt holes 312, 322, screws may be used or O-rings may be inserted. A wire for the power supplied to the lighting unit 40 is inserted through the upper frame 32 to be closed. It is preferable to connect an upper frame cover 33 to a top end of the upper frame 32, to protect a wire unit inserted into the upper frame 32. If a battery is used for the power, the battery may be built in the upper frame cover 33.

When the LED lighting device according to the present invention is used as a fish attraction lamp, since light wavelength is different according to fish species, a blue color uses the wavelength of 400˜500 nm, a green color uses the wavelength of 500˜570 nm, and a red color uses the wavelength of 600˜800 nm, among the LED colors.

Since the lighting pipe 34 has the cylindrical shape, it is preferable to form flat sections 311, 321 at one or both sides of the lower frame 31 and upper flame 32 connected to the lower and upper ends of the lighting pipe 34. The flat sections prevent the LED lighting device from rolling on the floor.

Preferably, the LED lighting device may further comprise a remote control (not shown), to change the color of the light emitted from the LED elements 42 or to flicker the light. The LED lighting device may further comprise an attachment unit 36 in a spike or harpoon shape at the lower end of the lower frame 31. The attachment unit 36 is used to vertically secure the LED lighting device on the ground or a certain place, to bring the light for a user's night outdoor activities.

In the LED lighting device according the present invention described above, only one lighting device is installed as a light lamp. But, a plurality of the LED lighting devices according to the present invention may be connected together in series.

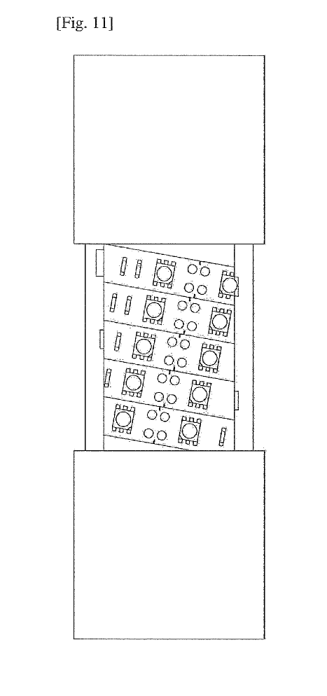

As shown in FIG. 11, the LED lighting device may be structured by attaching a flexible strip/rope-typed LED on the market by using an adhesive, without attaching the PCB to the outer circumferential surface of the inner frame positioned inside the lighting pipe. Since the flexible strip/rope-typed LED is in the form of a line where the LED elements are mounted at regular intervals, it is wound around the outer circumferential surface of the inner frame, to be glued thereon.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

[Description of numbers for constituents in drawings]

| | |
|---|---|
| 10, 20: lighting device | 11, 21: front frame |
| 12, 22: back frame | 13: PCB |
| 14: LED | 15: lens |
| 16: O-ring | 17: lens clamping bolt |
| 18: liquid | |
| 30: lighting device | 31: lower frame |
| 32: upper frame | 33: upper frame cover |
| 34: lighting pipe | 35: inner frame |
| 36: attachment unit | |
| 40: lighting unit | 41: PCB |
| 42: LED element | 43: control circuit and sensor unit |

1. An LED lighting device in a heat radiating, waterproof and moisture-proof structure using a fluid, comprising:
a front frame in which a fluid space is formed at its back side, through-holes are formed, at regular intervals, at its front side and a fluid inlet is formed;
a back frame in a flat shape to be connected to the back side of the front frame to complete a frame and to close the fluid space;
a PCB with LEDs installed at regular intervals, at its front side, to emit light through the through-holes of the front frame; and
a fluid which is a high molecular compound extracted from mineral oil, to fill the fluid space of the front frame.

2. The LED lighting device according to claim 1, wherein a plurality of the frames each formed by connecting the front frame and the back frame are arranged in 2˜6 lines, spacing apart from one another at equal intervals, and the ends of the frames are connected together to be in a single body.

3. The LED lighting device according to claim 2, wherein the frames have a fluid channel enabling the fluid filling the inside of each frame to communicate together.

4. The LED lighting device according to claim 1, further comprising: a lens installed in front of each of the LEDs.

5. The LED lighting device according to claim 1, wherein the PCB is provided with bimetal to block or turn off a circuit at a certain temperature.

6. The LED lighting device according to claim 1, wherein the fluid inlet is closed after the fluid is supplied through the fluid inlet of the front frame.

7. The LED lighting device according to claim 1, further comprising: an aluminum heat radiation panel installed on an outer surface of the back frame.

8. An LED lighting device in a heat radiating, waterproof and moisture-proof structure using a fluid, comprising:
alighting pipe in a cylindrical shape made of a transparent material;
a PCB positioned inside the lighting pipe, on which LED elements are installed at equal intervals and lengthwise;
a fluid to fill the inside of the lighting pipe, the fluid being a high molecular compound extracted from mineral oil; and
a lower frame and an upper frame each having a cylindrical shape, to be respectively connected to a lower end and an upper end of the lighting pipe.

9. The LED lighting device according to claim 8, wherein further comprising: an inner frame in a flat shape or in a shape in which a plane is polygonal, to be provided inside the lighting pipe, wherein the PCB is attachably connected to an outer surface of the inner frame in the flat or polygonal shape.

10. The LED lighting device according to claim 9, wherein a top and a bottom of the lighting pipe are connected to stoppers and the stoppers include groves shaped to receive the upper end and lower end of the inner frame or PCB.

11. The LED lighting device according to claim 8, wherein a top of the upper frame is connected to an upper frame cover and the upper frame cover is structured to include a battery inside.

12. The LED lighting device according to claim 8, wherein the PCB is further provided with at least one of a camera, a water level sensor, a proximity sensor for fish attraction and a current leak sensor.

13. The LED lighting device according to claim 1, wherein, among the LED colors, the wavelength of a blue color is 400˜500 nm, the wavelength of a green color is 500˜570 nm and the wavelength of a red color is 600˜800 nm.

14. The LED lighting device according to claim 8, further comprising: a remote control to change or flicker the colors of the LED elements.

15. The LED lighting device according to claim 8, further comprising: a lens installed in front of each of the LED.

16. An LED lighting device in a heat radiating, waterproof and moisture-proof structure using a fluid, comprising:
a lighting pipe in a cylindrical shape made of a transparent material;
an inner frame positioned inside the lighting pipe and having a shape in which a plane is circle or polygonal;
a stripe/rope-shaped LED attached to an outer circumferential surface of the inner frame;
a fluid to fill the inside of the lighting pipe, the fluid being a high molecular compound extracted from mineral oil; and
a lower frame and an upper frame each having a cylindrical shape, to be respectively connected to a lower end and an upper end of the lighting pipe.
